(19) United States
(12) Patent Application Publication
(10) Pub. No.: US 2023/0121645 A1
(43) Pub. Date: Apr. 20, 2023

(54) SYSTEMS, MEDIA, AND METHODS FOR DETERMINING PURCHASE ELIGIBILITY OF PRODUCTS/SERVICES UTILIZING ONE OR MORE DIFFERENT PAYMENT OPTIONS HAVING ONE OR MORE PAYMENT RESTRICTIONS

(71) Applicant: Sika Health, Inc., New York, NY (US)

(72) Inventor: Ami Kumordzie, New York, NY (US)

(21) Appl. No.: 17/961,013

(22) Filed: Oct. 6, 2022

Related U.S. Application Data
(60) Provisional application No. 63/255,700, filed on Oct. 14, 2021.

(51) Int. Cl. G06Q 20/40; G06Q 20/12; G06Q 20/38; G06F 40/205

(52) U.S. Cl. CPC G06Q 20/405; G06Q 20/12; G06Q 20/389; G06F 40/205

(57) ABSTRACT

Techniques determine purchase eligibility of products/services utilizing one or more different payment options, each of which may have different payment restrictions. An electronic transaction platform may analyze a plurality of different input criteria to determine if one or more different payment options are eligible to purchase the products/services. The electronic transaction platform may analyze payment restriction information for the different payment options in conjunction with other input criteria to determine which payment options are eligible and can be utilized to purchase the products/services for the end user or a beneficiary. A product/service is eligible for purchase utilizing a payment option, not eligible for purchase utilizing the payment option, or conditionally eligible for purchase utilizing the payment option.

### CROSS-REFERENCE TO RELATED APPLICATIONS

The present application claims the benefit of U.S. Provisional Patent Application Ser. No. 63/255,700, which was filed on Oct. 14, 2021, by Ami Kumordzie for SYSTEMS, MEDIA, AND METHODS FOR DETERMINING PURCHASE ELIGIBILITY OF PRODUCTS/SERVICES UTILIZING ONE OR MORE DIFFERENT PAYMENT OPTIONS HAVING ONE OR MORE PAYMENT RESTRICTIONS, which is hereby incorporated by reference in its entirety.

### BRIEF DESCRIPTION OF THE DRAWINGS

The description below refers to the accompanying drawings, of which:

FIG. 1 is a high-level block diagram of an example architecture for determining purchase eligibility of products/services utilizing one or more different payment options having one or more payment restrictions in accordance with illustrative embodiments of the present invention;

FIG. 2 is an illustrative eligibility data structure that may be generated in accordance with illustrative embodiments of the present invention;

FIG. 3 is an illustrative merchant data structure generated to include merchant data and an assigned eligibility classification that is determined in accordance with illustrative embodiments of the present invention;

FIG. 4 is an illustrative different merchant data structure that may be generated in accordance with illustrative embodiments of the present invention;

FIG. 5A is an illustrative user interface that may be generated in accordance with illustrative embodiments of the present invention; and

FIG. 5B is an illustrative user interface that may be generated for a product determined to be conditionally eligible in accordance with illustrative embodiments of the present invention.

### DETAILED DESCRIPTION OF AN ILLUSTRATIVE EMBODIMENT

In one or more embodiments, the disclosed systems, methods and media include determining purchase eligibility of products/services utilizing one or more different payment options, each of which may have different payment restrictions. In an embodiment, an electronic transaction platform may analyze a plurality of different input criteria to determine if one or more different payment options are eligible to purchase the products/services. Specifically, the electronic transaction platform may analyze payment restriction information for the different payment options in conjunction with other input criteria, as will be described in further detail below, to determine which payment options are eligible and can be utilized to purchase the products/services for the end user or a beneficiary (e.g., a child of an adult who utilizes his/her payment option to purchase the product/service for the child).

The different payment options having one or more payment restrictions may include, but are not limited to, restricted accounts (e.g., a health savings account (HSA) and a flexible savings account (FSA)), health insurance plans, government benefits (e.g., food stamps), manufacturer rebates, etc. Although the one or more examples herein may refer to payment option eligibility for an HSA or an FSA, it is expressly contemplated that the one or more embodiments as described herein may be applicable to any of a variety of different payment types and/or options that include one or more payment restrictions. As such, it should be understood to those skilled in the art that the examples as described herein that refer to an HSA or an FSA are for illustrative purposes only.

Additionally, the payment restriction information may include eligibility rules that govern which payment options are allowed to be utilized to purchase particular items/services. Illustratively, an eligibility rule may indicate whether a product/service is (i) eligible for purchase utilizing a payment option, (ii) not eligible for purchase utilizing the payment option, or (iii) conditionally eligible for purchase utilizing the payment option. For example, an eligibility rule may indicate that an HSA may be a payment option for the purchase of a particular medication but cannot be a payment option for a cosmetic dental procedure. As another example, an eligibility rule may indicate that an HSA may be a payment option for a stationary bike if (e.g., conditional eligibility) the end user purchasing the stationary bike has a particular medical condition, e.g., diabetes.

In an embodiment, the electronic transaction platform may receive payment restriction information from a variety of different sources, e.g., over a computer network. For example, the different sources may be input criteria providers that include, but are not limited to, the Internal Revenue Service (IRS) systems, health systems, employer document systems, benefit plan systems, etc. In an embodiment, the eligibility rules may be utilized by the electronic transaction platform to generate one or more different data structures that can be utilized to determine purchase eligibility utilizing the one or more different payment options.

In an embodiment, other input criteria, which also may be utilized to determine payment option eligibility, may include characteristic information associated with the product/service. For example, the characteristic information may describe the product/service, or may be a unique identifier identifying the product/service, inventory information (e.g., information indicating the inventory of the item/service at a merchant), billing codes that are related to the product/service, explanation of benefits (EOB) or services list, etc. Additionally, the other input criteria, which also may be utilized to determine payment option eligibility, may include characteristic information associated with the end user interested in purchasing the item/service and/or the beneficiary. For example, the characteristic information may describe a health status, health conditions, diagnoses of illness or symptoms, intended use of the product/service, reasons for purchasing the items/services, etc.

The electronic transaction platform may receive and utilize the different types of input criteria to determine, as will be described in further detail below, if a product/service at a merchant is eligible, non-eligible, or conditionally eligible for purchase utilizing each of the different payment options. Based on the determinations, the electronic transaction platform may classify each product/service as eligible with a payment option, non-eligible with a payment option, or conditionally eligible with a payment option and provide the classifications to one or more merchants. The merchants may categorize their inventory based on, for example, the payment option eligibility classifications. As such, merchants can better understand which payment options can be utilized to purchase their products/services, which in turn can facilitate increased business at the merchant.

After determining payment option eligibility, the electronic transaction platform may initiate the electronic transaction for the purchase of the product/service, between the end user and the merchant, utilizing the determined eligible payment option. In an embodiment, the electronic transaction platform may provide an indication, e.g., electronic message, to the merchant of the product/service that the end user is allowed, not allowed, or conditionally allowed to purchase the product/service utilizing the determined payment option. In addition, or alternatively, the end user may receive an indication, e.g., electronic message on mobile phone, that the end user is (?) allowed, not allowed, or conditionally allowed to purchase the product/service from the merchant utilizing the determined payment option. In addition, or alternatively, the electronic transaction platform, which may embody a serverless architecture, may segregate products/services to be purchased by the end user based on the determined payment option to enable improved transaction processing. For example, all products/services that are eligible/ineligible for purchase using an HSA may be segregated using techniques, such as queuing, that enable asynchronous communication, data persistence and workload scaling to improve transaction performance. To that end, all eligible products/services may be segregated into a first queue and all ineligible products/services may be segregated into a second queue.

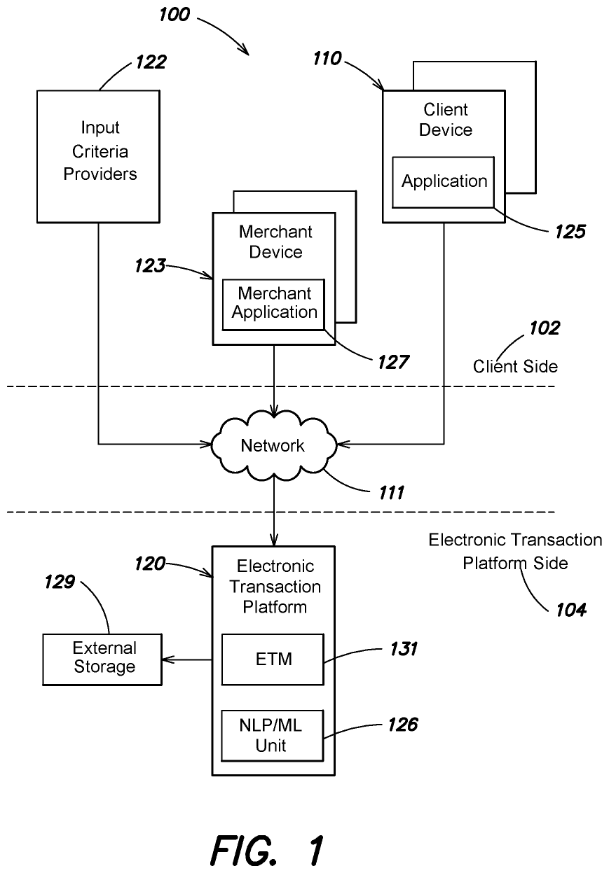

FIG. 1 is a high-level block diagram of an example architecture 100 for determining purchase eligibility of products/services utilizing one or more different payment options having one or more payment restrictions. The architecture 100 may be divided into a client side 102 and an electronic transaction platform side 104. The client side 102 may include one or more local client devices 110, one or more input criteria providers 122, and one or more merchant devices 123. The electronic transaction platform side 104 may include electronic transaction platform 120 that is remote (e.g., and/or physically separated) from the devices of the client side 102 and that is accessible to the end users (e.g., operators of the client devices 110, merchant devices 123, and input criteria providers 122) via network 111.

In an embodiment, the network 111 may include local network segments illustratively embodied as shared local area networks (LANs) or virtual LANs (VLANs), and/or remote network segments illustratively embodied as point-to-point links, wide area networks (WANs), and/or VPNs implemented over a public network (such as the Internet). Communication over the network segments may be affected by exchanging discrete frames or packets (messages) of data according to pre-defined protocols, such as the Transmission Control Protocol/Internet Protocol (TCP/IP) and the OpenID Connect (OIDC) protocol, although other protocols, such as the User Datagram Protocol (UDP) or the HyperText Transfer Protocol Secure (HTTPS) may also be advantageously employed.

Each computing device, e.g., one or more local client devices 110, input criteria providers 122, merchant devices 123, and electronic transaction platform 120 may include processors, memory/storage, a display screen, and other hardware (not shown) for executing software code (e.g., instructions embodied as computer programs and processes, hereinafter “applications”), storing data and data structures, and/or displaying information. The processors may, in turn, include processing elements and/or circuitry configured to execute the applications and manipulate the data structures. Illustratively, the electronic transaction platform may embody the serverless architecture of a cloud-based platform, e.g., where various applications are hosted by a third-party service such as a cloud service provider (CSP).

It will be apparent to those skilled in the art that other types of processing architectures, such as architectures directed to monolithic applications or microservices, and associated elements, including various computer-readable media, may be used to store and execute program instructions pertaining to the embodiments described herein. Also, while the embodiments herein are described in terms of software code, processes, and computer programs (e.g., applications) stored in memory, alternative embodiments also include the code, processes and programs being embodied as logic, components, modules and/or engines consisting of hardware, software, firmware, or combinations thereof.

A local client device 110 and a merchant device 123 may provide a variety of user interfaces and non-processing intensive functions. For example, a local client device 110 and a merchant device 123 may provide a user interface, e.g., a graphical user interface and/or a command line interface, for receiving user input and displaying output according to the one or more embodiments described herein. In an embodiment, the client device 110 and the merchant device 123 may be a server, a workstation, a platform, a mobile device, a network host, or any other type of computing device. The client device 110 and the merchant device 123 may, respectively, store and execute application 125 and merchant application 127. In another embodiment, the applications 125 and merchant application 127 may perform one or more different functions for end users that operate client devices 110 and merchant devices 127. For example, the application 125 may be provided by the electronic transaction platform 120 and installed on client device 110 such that the end user may execute application 125 to determine which of his/her payment options are eligible to purchase a product/service at a merchant according to the one or more embodiments described herein. Additionally, merchant application 127 may be provided by the electronic transaction platform 120 and installed on merchant device 123 such that the end user, e.g., merchant, may execute application 127 to determine the purchase eligibility classification (e.g., eligible, non-eligible, conditionally eligible) for each of the merchant's inventory items/services with each payment option according to the one or more embodiments described herein.

The one or more input criteria providers 122 on client side 102 can be any of a variety of different types of storage architectures or systems that provide, over network 111, input criteria to the electronic transaction platform 120. For example, the storage architecture may include, but is not limited to, cloud storage, databases, applications, application program interfaces (APIs), the Internet of Things (IoT) storage, hard disk drives, solid state drives, etc. For example, input criteria provided by the one or more input criteria providers 122 may include, but is not limited to, payment restriction information, characteristic information describing the product/service to be purchased, characteristic information associated with the end user or beneficiary for which the product/service is to be purchased, eligibility rules, etc. In an embodiment, the end user may utilize local client device 110 to provide input criteria to the electronic transaction platform 120 over network 111.

The electronic transaction platform 120 may store and execute electronic transaction module (ETM) 126 that may implement the one or more embodiments described herein. In an embodiment, the ETM 126 may utilize payment restriction information for different payment options in conjunction with other input criteria (e.g., characteristic information associated with the product/service and/or characteristic information associated with the end user or beneficiary) to determine which payment options are eligible to purchase the product/of service. For example, the ETM 126 may determine the eligible payment options for each product/service provided by a merchant, and classify each product/service as being eligible, non-eligible, or conditionally eligible with each payment option as will be described in further detail below.

In an embodiment, the ETM 126 may call/execute to generate one or more data structures that define payment eligibility for products/services as described in further detail below. In an embodiment, the one or more advanced analytic techniques may include, but are not limited to, natural language processing (NLP)/machine learning (ML), data mining, historical data analysis, external data sources searches, web crawling, etc. In an embodiment, the one or more advanced analytic techniques may be implemented by NLP/ML unit 131. Although the one or more examples herein may refer to utilizing NLP/ML to determine payment option eligibility for the purchase of products/services, it is expressly contemplated that any of a variety of different advanced analytic technique may be utilized to determine payment option eligibility according to the one or more embodiments described herein. As such, it will be understood to those skilled in the art that the examples of utilizing NLP/ML as described herein are for illustrative purposes only.

The ETM 126 may utilize the generated data structures to determine if a merchant product/service is eligible, non-eligible, or conditionally eligible for each payment option. In an embodiment, the one or more generated data structures may be stored in memory (not shown) of the electronic transaction platform 120 and/or external storage 129 that may be embodied as a relational database. During operation of the one or more embodiments described herein to determine purchase eligibility, the data structures may be cached in memory and accessed/utilized to improve the underlying computational performance of the electronic transaction platform 120 when determining purchase eligibility. The ETM 126 may access the generated data structures to execute and determine the purchase eligibility of the merchant products/services to then allow, initiate, or deny, for example, a purchase of a product/service by an end-user (e.g., consumer) as will be described in further detail below.

In an embodiment, the ETM 126 may obtain, i.e., ingest, a variety of different data from one or more different sources such as input criteria providers 122. In an embodiment, the data may include, but is not limited to, payment restriction information and characteristic information describing the product/service to be purchased. In an embodiment, the data obtained may include free text defining different rules indicating whether medical/dental expenses are eligible for coverage, i.e., payment, utilizing an HSA and/or FSA, not eligible for coverage utilizing an HSA and/or FSA, and/or conditionally eligible for coverage utilizing an HSA and/or FSA based on one or more different conditions (e.g., characteristics of the end user and/or beneficiary).

For example, such input criteria providers 122 that may provide the data may include, but are not limited to, publicly accessible online sources (e.g., IRS online sources) that include payment restriction information, health systems and health online sources that, in turn, include payment restriction information, employer document systems and employer online sources that, in turn, include payment restriction information, benefit plan systems and benefit plan online sources that, in turn, include payment restriction information, etc. For example, and according to the one or more embodiments described herein, two sources may be the IRS publication for Medical and Dental expenses that may be found at https://www.irs.gov/publications/p502#en_US_2020_publink1000179074, and different publicly available IRS memos such as those covering home exercise equipment that may be found at https://www.irs.gov/pub/irs-wd/03-0202.pdf.

In an embodiment, the ETM 126 may invoke (e.g., call) and/or execute NLP/ML unit 131 to utilize (employ) one or more rule-based NLP techniques, e.g., embodied as algorithms and conditional logic, to process the obtained data and generate one or more eligibility data structures, e.g., tables, arrays, linked lists, etc. The ETM 126 may utilize the generated data structures to determine purchase eligibility and then allow, initiate, or deny a purchase as will be described in further detail below. Although FIG. 1 depicts the ETM 126 and NLP/ML unit 131 as separate modules/components, it is expressly contemplated that a single module/component may implement the functions of the ETM 126 and NLP/ML unit 131 according to the one or more embodiments described herein.

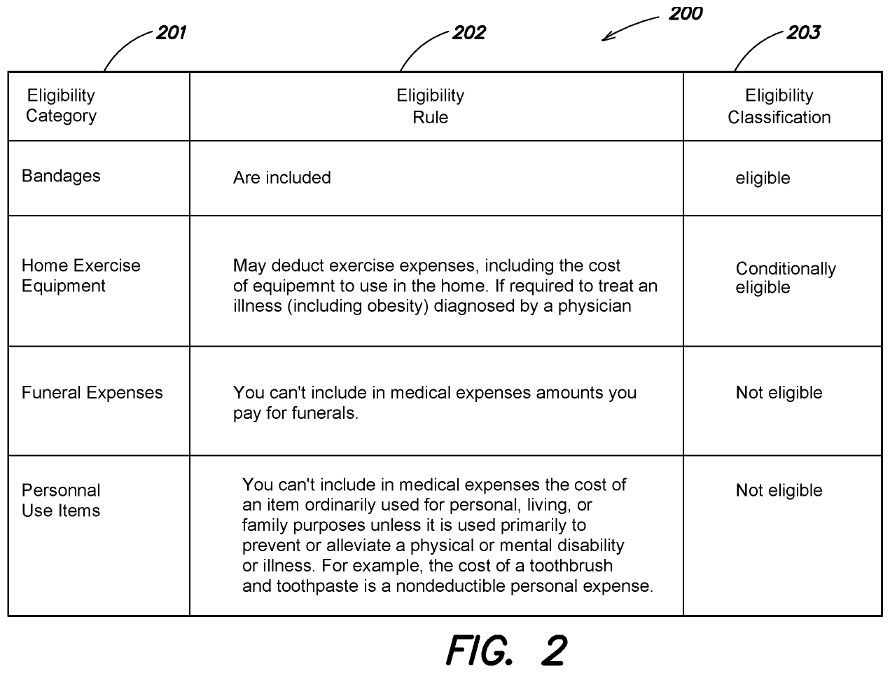

FIG. 2 is an illustrative eligibility data structure 200 that may be generated according to the one or more embodiments described herein. As will be described in further detail below, each row of the eligibility data structure can be generated/determined based on the identification of a predetermined eligibility term/phrase in the obtained data followed by the utilization of one or more NLP techniques.

The eligibility data structure 200 may include a column 201 titled eligibility category. The NLP/ML unit 131 may utilize the one or more NLP techniques to populate column 201 with different eligibility categories identified from the obtained data (e.g., obtained from an EOB, service list, billing codes, etc.). In an embodiment, the NLP/ML unit 131 may utilize an NLP technique that identifies one or more keywords in the obtained data as an eligibility category based on automatic (i.e., without human involvement) parsing and analysis of the data to discern a location of the one or more keywords in relation to a location of a predetermined eligibility term/phrase in the obtained data. For example, the NLP/ML unit 131 may determine that because a keyword precedes (e.g., directly precedes) or follows (e.g., directly follows) a predetermined eligibility term/phrase, the keyword in the obtained data is an eligibility category. Advantageously, processing of the obtained data by the NLP/ML unit ensures consistent and deterministic eligibility classifications and purchase eligibility through the use of underlying computer functionality improvements (such as, e.g., conservation of processor, memory and/or networking resource consumption) provided by the sophisticated rule-based analysis embodiments described herein, which, inter alia, obviate human involvement and potential error.

As an example, assume that the predetermined eligibility terms/phrases include, but are not limited to, “may deduct”, “can deduct”, “can't include”, and “included”. Such predetermined eligibility terms/phrases may be provided as seeds to the NLP/ML unit 131 that implements the NLP technique, and the NLP/ML unit 131 may identify a predetermined eligibility term/phrase in the obtained data. Once the predetermined eligibility term is identified, the NLP/ML unit 131 may identify a corresponding eligibility category based on a rule utilized for the NLP technique. For example, the rule may indicate that if a keyword precedes a predetermined eligibility term/phrase in the obtained data, while excluding particular types of words (e.g., articles and verbs), then the keyword is an eligibility category.

For this example, further assume that the obtained data states “bandages are included under HSA/FSA payments”. The NLP/ML unit 131 may utilize the NLP technique to identify the predetermined eligibility term of “included” in the obtained data. The NLP/ML unit 131 may utilize the NLP technique to determine that because the predetermined eligibility term of “included” is directly preceded by a verb, e.g., “are”, the identified verb is not an eligibility category. Additionally, the NLP/ML unit 131 may utilize the NLP technique to determine that because the noun “bandages” directly precedes both the identified verb and the identified predetermined eligibility term, the noun “bandages” is the eligibility category. As such, the NLP/ML unit 131 may populate the first entry in column 201, titled eligibility category, with the keyword “bandages”. The other entries, e.g., “home exercise equipment”, “funeral expenses”, and “personal use items”, of column 201 may be populated in a similar manner as described above.

The NLP/ML unit 131 may also utilize the NLP technique to determine, i.e., identify, an eligibility rule based on the identified predetermined eligibility term/phrase, i.e., seed, to populate column 202 titled eligibility rule. For example, the NLP technique may utilize a parsing technique to identify one or more words within a threshold distance of the one or more predetermined eligibility terms (e.g., seed), while discarding other words to identify the eligibility rule. Specifically, and in this example, an NLP rule may indicate that any words/phrases that follow the predetermined eligibility term of “included” are to be discarded/ignored. Additionally, the rule may indicate that the eligibility rule includes the predetermined eligibility term/phrase and any other terms/phrases that precede the predetermined eligibility term and follow the identified eligibility category.

Continuing with the example above for the bandages, the NLP technique may identify the term “are” that directly precedes the predetermined eligibility term of “included” and follows the identified eligibility category of “bandages”. As such, and based on the NLP rules as described above, the NLP unit may determine that the eligibility rule in this example is “are included”. The NLP/ML unit 131 may store the eligibility rule of “are included” in the corresponding entry of column 202. The other entries of column 202 may be populated in a similar manner and utilizing one or more similar or different NLP rules.

The NLP/ML unit 131 may additionally utilize an NLP technique, e.g., a parsing technique, with the eligibility rules in column 202 to populate column 203 titled eligibility classification. Specifically, the NLP/ML unit 131 may parse each eligibility rule in column 202 utilizing the NLP technique to classify the corresponding eligibility category in column 201 as either “eligible”, “not eligible”, or “conditionally eligible”. For example, an eligibility category may be classified as “eligible” when the NLP/ML unit 131 parses out, i.e., identifies, the words/phrases “always”, “can deduct”, “included” or similar words/phrases from the eligibility rule in column 202 when utilizing the NLP technique. Additionally, an eligibility category may be classified as “not eligible” when the NLP/ML unit 131 parses out the words/phrases “never”, “can't include”, “cannot deduct”, or similar words/phrases from the eligibility rule in column 202 when utilizing the NLP technique. Further, an eligibility category may be classified as “conditionally eligible” when the NLP/ML unit 131 parses out the word/phrase “may deduct”, “if required”, “unless”, or similar words/phrases from the eligibility rule in column 202 when utilizing the NLP technique.

As depicted in FIG. 2, column 203 is populated, in the manner described above, to classify each eligibility category identified in the corresponding entry of column 201. Continuing with the example above for the bandages, the NLP technique may identify the word “included” from the eligibility rule in column 202 for eligibility category “bandages” of column 201. As such, the NLP/ML unit 131 may classify “bandages” of column 201 as being eligible, i.e., always eligible, for HSA/FSA payment and store the classification of “eligible” in the corresponding entry of column 203. The other entries of column 203 may be populated in a similar manner as described above to classify each of the eligibility categories in column 201. Therefore, each row in eligibility data structure 202 can be generated based on the identification of a predetermined eligibility term in the obtained data and the utilization of one or NLP techniques as described above.

As such, the eligibility data structure 200 provides an improved mapping such that each determined eligibility category has a direct and singular eligibility classification (e.g., eligible, not eligible, or conditionally eligible) determined according to the one or more embodiments described herein. Moreover, use of the eligibility data structure 200 in connection with automatic parsing and rule-based analysis to determine purchase eligibility minimizes (substantially reduces) erroneous classifications compared to conventional, manual techniques that that require human analysis and subjectivity to determine purchase eligibility.

Further, the ETM 126 operates to conserve processing, memory and/or networking resources by accessing and accurately indexing into the automatically generated eligibility data structure to determine an eligibility classification for a product/service. In contrast, conventional techniques typically require substantially greater resources to gather and organize and store voluminous, raw data from various sources (e.g., over local and/ remote network segments), and then analyze and process that data to determine potential eligibility.

Additionally, and after the generation of the eligibility data structure 200, the raw obtained data can be discarded/pruned, (e.g., does not need to be maintained or stored in memory and/or persistent storage) to advantageously conserve such memory/storage resources according to the one or more embodiments descried herein. That is, the generation of the eligibility data structure 200 utilized to determine purchase eligibility allows the electronic transaction platform 120 to reduce the memory/storage “footprint” by discarding the raw data after the data structure 200 is generated. This aspect of the described embodiments is, once again, an improvement over conventional techniques that need to store and maintain the voluminous raw data to determine eligibility. In other words, the resource conservation technique described herein provides yet another advancement over existing technology of electronic transaction processing through improvement to underlying computer platform functionality.

As will be described in further detail below, the ETM 126 may utilize the generated eligibility data structure 200 with merchant data that may, for example, describe merchant products/services, such that the merchant products/services can be classified for purchase eligibility.

Specifically, a merchant may utilize merchant application 127 executing on merchant device 123 to provide merchant data to the electronic transaction platform 120. In addition or alternatively, the electronic transaction platform 120 may obtain, e.g., “pull”, the merchant data from merchant device 123, one or more websites associated with the merchant, and/or storage devices (not shown). The merchant data may include information describing the products/services offered, e.g., sold, by the merchant. For example, the merchant data may be pre-itemized and structured as a database, e.g., table, or other type of data structure such each product/service has its own corresponding unique identifier and other associated merchant data. For example, the merchant data for each product/service may include, but is not limited to, universal identifiers for the product/service, merchant specific identifiers for the product/service, a name of the product/service, and/or item attributes describing the features/characteristics of the product/service.

The ETM 126 may utilize the eligibility data structure 200 in conjunction with the merchant data to determine if the product/service offered by the merchant is eligible, not eligible, or conditionally eligible with an HSA and/or FSA. Specifically, the ETM 126 may invoke/execute the NLP/ML unit 131 to employ one or more NLP techniques and determine, as described below, if an eligibility category from the eligibility data structure 200 matches or substantially matches merchant data that describes the merchant product/service. If so, the NLP/ML unit 131 may identify the eligibility classification in column 203, corresponding to the matching eligibility category in column 201, and assign the eligibility classification to the merchant's product/service.

For example, assume that a department store is a merchant that sells, among other things, bandages. As such, the merchant data provided to or obtained by the electronic transaction platform 120 may include merchant data associated with the bandages as well as merchant data associated with other products/services offered by the merchant.

Assume further that the merchant data for the bandages includes, among other things, a product name of “Band-Aid Flexible Fabric Brand Adhesive Bandages” and a description of “Try Band-Aid Brand Flexible Fabric Adhesive Bandages”. The ETM 126 may utilize an NLP technique, e.g., parsing technique, with the product name and description to identify frequently occurring keywords. In an embodiment, the NLP technique may employ rule-based analysis to discard certain words/phrases such that the words/phrase cannot qualify as keywords. Such words/phrases may include articles (e.g., “a”, “an”, the), certain verbs (e.g., be), or other commonly occurring words.

The NLP technique may employ limits and conditional logic to, e.g., utilize a threshold value and determine that if a keyword appears in the product name and/or the description a predetermined number of times that is greater than equal to the threshold value (e.g., 2). If so, the NLP technique may render a decision that the keyword should be included in an ordered list to be utilized with the eligibility data structure 200. If a keyword appears in the product name and/or the description a number of times that is less than the threshold value, the NLP technique determines that the keyword should be ignored. The ETM 126 may then determine if any of the keywords in the ordered list match or substantially match an eligibility category in column 201 of the eligibility data structure 200.

In this example, the NLP/ML unit 131 may parse the product name and description and determine that because the keyword “bandages” appears twice, the keyword “bandages” may be compared against the eligibility categories in column 201 of eligibility data structure 200. The NLP/ML unit 131 may then determine that the keyword “bandages” matches or substantially matches the eligibility category, in this example, “bandages” of column 201 of eligibility data structure 200. As such, the ETM 126 may assign the eligibility classification, from column 203 corresponding to bandages of column 201, to the merchant's bandage product.

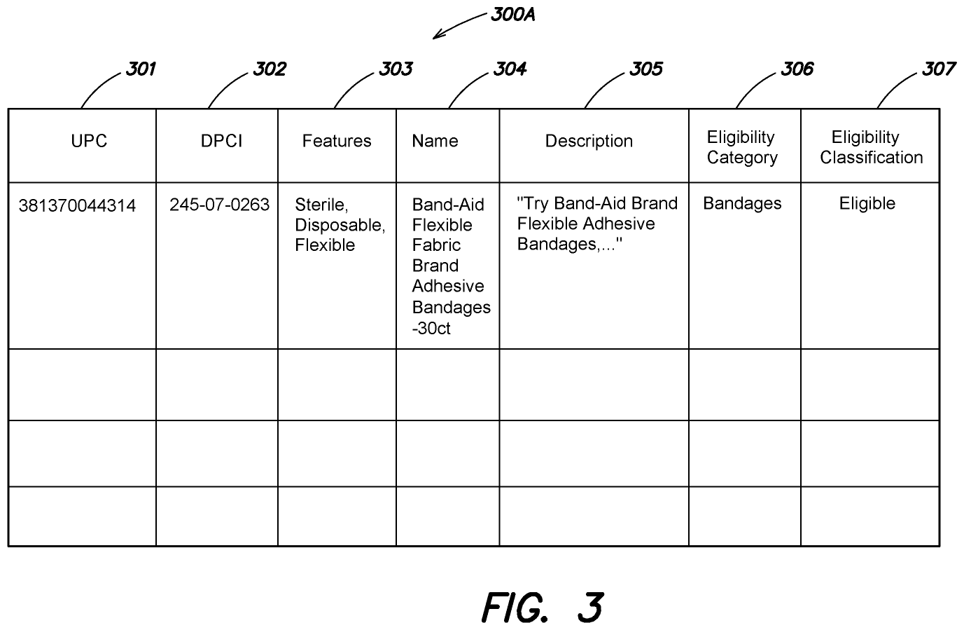

In an embodiment, the ETM 126 may generate a merchant data structure, e.g., merchant data structure 300A, that includes the merchant data and the eligibility classification, determined and assigned utilizing the eligibility data structure 200, as described above. FIG. 3 is an illustrative merchant data structure 300A generated to include merchant data and an assigned eligibility classification that is determined according to the one or more embodiments described herein. Merchant data structure includes columns 301, 302, 303, 304, and 305 include merchant data. Specifically, columns 301, 302, 303, 304, and 305 respectively store a Universal Product Code (UPC) (a universal code) for a product/service, a department—class—item (DPCI) code (merchant code) for a product/service, a description of the features of the product/service, a name of the product/service, and a description of the product/service.

In addition to merchant data, the merchant data structure 300A may store information obtained from the eligibility data structure 200. Specifically, and based on a determination that merchant data, for a merchant product/service, matches an eligibility category of column 201, the ETM 126 may also store the eligibility category and the eligibility classification, from eligibility data structure 200, in data structure 300A. In this example, the merchant data for bandages is determined to match or substantially match eligibility category “bandages” in column 201. As such, the ETM 126 may store “bandages”, from column 201, in column 306 titled eligibility category. Additionally, the ETM 126 may store “eligible”, from column 203, in column 307 titled eligibility classification. Although the merchant data structure 300A includes a single entry for simplicity and ease of understanding, it is expressly contemplated that the merchant data structure 300A may include any number of a plurality of entries, each of which may correspond to a different merchant product/service.

In an embodiment, and when merchant products/services are not itemized and instead multiple products/services (e.g., different packages of a product/service) are organized under the same category (e.g., bikes), the ETM 126 may determine an eligibility classification for the different merchant products/services, under the same category, utilizing an NLP technique that identifies keyword from one or more product descriptions. For example, assume that a merchant sells an exercise bike as a plurality of different package. Specifically, the merchant may sell the exercise bike as packages with additional/different features or accessories where each package is included under the same category of “bikes”. For example, the product packages may have the following product descriptions provided by a manufacturer of the exercise bike which, in this example, is Company PPP:

| Categories | Description |
|---|---|
| Bikes1 | “Exercise Bike, Warranty, Delivery” |
| Bikes2 | “As above plus shoes, weights, headphones” |
| Bikes3 | “As above plus bike mat, heart rate monitor” |
| Bikes4 | “As above plus camelback bottle” |

Additionally, assume the merchant product description states “Company PPP makes at-home gym equipment, has an exercise app, and produces workout videos that customers can live-stream through PPP products”. The NLP/ML unit 131 may utilize an NLP algorithm to identify one or more frequently used keywords from the product descriptions and/or merchant product description. In an embodiment, a keyword is identified based on the keyword appearing, i.e., included within, the product description and/or merchant product description more than a threshold number of times and/or its location relative to predetermined eligibility terms/phrases (e.g., “include”), in a similar manner as described above. In this example, assume that the NLP/ML unit 131 identifies keywords “bikes” and “home equipment”. The NLP/ML unit 131 may then discard any identified keywords that do not match or substantially match any of the eligibility categories in column 201 of eligibility data structure 200. In this example, the identified keyword “bikes” does not match or substantially match any of the eligibility categories in column 201. As such, the ETM 126 may discard or ignore the identified keyword “bikes.” Continuing with this example, the ETM 126 may determine that identified keyword “home equipment” substantially matches the second entry in column 201 of “home exercise equipment”.

In response to determining a match, the ETM 126 may determine a relatedness between the terms/phrases (e.g., bike, shoes, mat, etc.) of the product description with the identified keyword of “home equipment”. For example, the ETM 126 may utilize one or more sentence-vector NLP tools to determine a relatedness score between the terms/phrases of the product description and the identified keywork of “home equipment”. If the relatedness score is greater than or equal to a threshold value, the ETM 126 may determine that the product package matches or substantially matches the eligibility category. However, if the relatedness score is less the threshold value, the ETM 126 may determine that the product package does not match the eligibility category. In this example, assume the related score determined for the first product package that includes the “Exercise Bike, Warranty, Delivery” is greater than the threshold value and thus the product package matches the eligibility category of “home exercise equipment”. Further, and in this example, assume the related score determined for the other product packages is less than the threshold value and thus the other packages do not match the eligibility category of “home exercise equipment.”

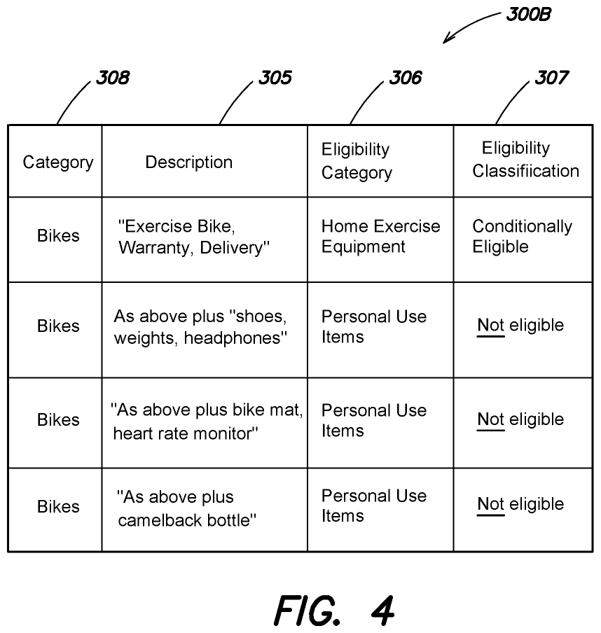

FIG. 4 is an illustrative merchant data structure 300B that may be generated according to the one or more embodiments described. herein. In an embodiment, the ETM 126 may generate merchant data structure 300B that is similar to merchant data structure 300A. Specifically, merchant data structure 300B may include column 308 titled category that describes a category of a product/service and column 305 titled description that describes the product/service. Additionally, the merchant data structure 300B includes column 306 titled eligibility category. Further, the merchant data structure 300B includes column 307 titled eligibility classification. As such, the merchant data structure 300B may store the determined eligibility classifications for each merchant product/service utilizing one or more NLP techniques with product descriptions.

The merchant data structures 300A and 300B may be utilized when, for example, an end user wants to purchase a product/service utilizing an HSA or FSA. Specifically, the merchant application 127 may be installed on merchant device 123 with the merchant data structure 300A and/or merchant data structure 300B. In this example, assume that the end user intends to purchase bandages and pencils from the merchant “Seller of Things” who only sells bandages and pencils. In an embodiment, the end user may utilize client device 110 to select the bandages and pencils to purchase the bandages and pencils from “Seller of Things”. Based on the selection, client device 110 may execute the application 125 to send a query message to (1) merchant application 127 executing on merchant device 123, and/or (2) electronic transaction platform 120. In response to receiving the query message, the merchant application 127 and/or the ETM 126 may access the merchant data structure (e.g., 300A or 300B) generated for merchant “Seller of Things” to determine the eligibility classification for each item to be purchased.

For example, a unique identifier or keyword associated with each purchased item may be utilized to index into the merchant data structure (e.g., 300A or 300B) to determine if the unique identifier or keyword matches the item of purchase identified in the merchant data structure. For example, assume that the merchant data structure 300A is generated for “Seller of Things” and that the merchant data structure is stored at the electronic transaction platform 120 and at the merchant device 123. Additionally, assume that the UPC for bandages to be purchased by the end user is “381370044314” and the UPC for the pencils to be purchased by the end user is “245585766511”. As such, the application 110 may provide a query message, including the two UPCs, to merchant device 123 and/or electronic transaction platform 120 to index into merchant data structure 300A.

Specifically, the ETM 126 may determine that the UPC for the bandages matches the UPC stored in column 301 for bandages. As such, the ETM 126 may identify the corresponding eligibility classification of “eligible” in column 307 for bandages. As such, the ETM may determine that the bandages to be purchased by the end user at merchant “Seller of Things” is eligible for payment using an HSA and/or FSA. By querying the merchant data structure 300A at the merchant device 123, merchant application 127 may determine the eligibility classification for bandages in a similar manner. Because the UPC for pencil is not identified in the merchant data structure 300A, the ETM 126 may determine that the pencil to be purchased by the end user at merchant “Seller of Things” is not eligible for payment using an HSA and/or FSA. Again, querying of the merchant data structure 300A at the merchant device 123 enables the merchant application 127 to determine the eligibility classification for bandages in a similar manner.

The determined eligibility classification may be provided to the application 125 executing on client device 110, and the application 125 may separate, i.e., segregate, the product/services to be purchased into an eligible category and a non-eligible category. The application 125 may then determine a total cost (e.g., including tax, shipping, etc.) for each category such that the products/services in the eligible category can be purchased using an HSA and/or FSA, while products/services in the non-eligible category can be purchased using a different payment option (e.g., conventional credit card or debit card).

As another example, assume that the merchant data structure 300B is generated for “Seller of Things” that only sells exercise and associated accessories, and that the merchant data structure is stored at the electronic transaction platform 120 and at the merchant device 123. Additionally, assume that the end user is interested in purchasing a product package for an exercise bike package that includes warranty and delivery. As such, the application 110 may provide a query message, including the description of products to be purchased, to merchant device 123 and/or electronic transaction platform 120 to index into merchant data structure 300B.

Specifically, the ETM 126 may determine that the description of the exercise back with warranty and delivery matches or substantially matches the first entry in column 305 of FIG. 4. As such, the ETM 126 may identify the corresponding eligibility classification of “conditionally eligible” in column 307 for the first package option. As such, the ETM 126 may determine that the exercise bike package with warranty and delivery, to be purchased by the end user at merchant “Seller of Things”, is conditionally eligible for payment using an HSA and/or FSA. If the merchant data structure 300A is queried at the merchant device 123, merchant application 127 may determine the eligibility classification for the first package option in a similar manner.

As such, the determined conditional eligibility classification may be provided to the application 125 executing on client device 110. Based on the conditional eligibility, the application 125 may display, on client device 110, one or more user interfaces that provide the end user with a variety of questions to answer related to the conditional eligibility. For example, the one or more user interfaces may ask (query) whether the purchase of the exercise bike is for a specific health condition. If the answer is “yes”, the end user may provide, via the one or more user interfaces and utilizing free-text, the one or more health conditions being relied upon to purchase the exercise bike. The provided health conditions may be reviewed by one or more health care professionals for validation, and the approval or non-approval from the health care professional may be electronically provided to the application to determine whether the condition is satisfied by the provided health condition. If so, the application 125 may provide an indication that the user is allowed to purchase the product/service using the HSA and/or FSA. If not, the application 125 may provide an indication that the user is not allowed to purchase the product/service using the HSA and/or FSA.

As explained, the merchant data structures 300A and 300B may be stored at the electronic transaction platform (e.g., in memory or external storage 129) and/or provided from the electronic transaction platform 200 to the merchant device 123 over network 111. The merchant data structures 300A and 300B may be utilized to determine if a merchant product/service to be purchased by an end user, e.g., consumer, is eligible for purchase utilizing the end user's payment option to initiate and complete the electronic transaction.

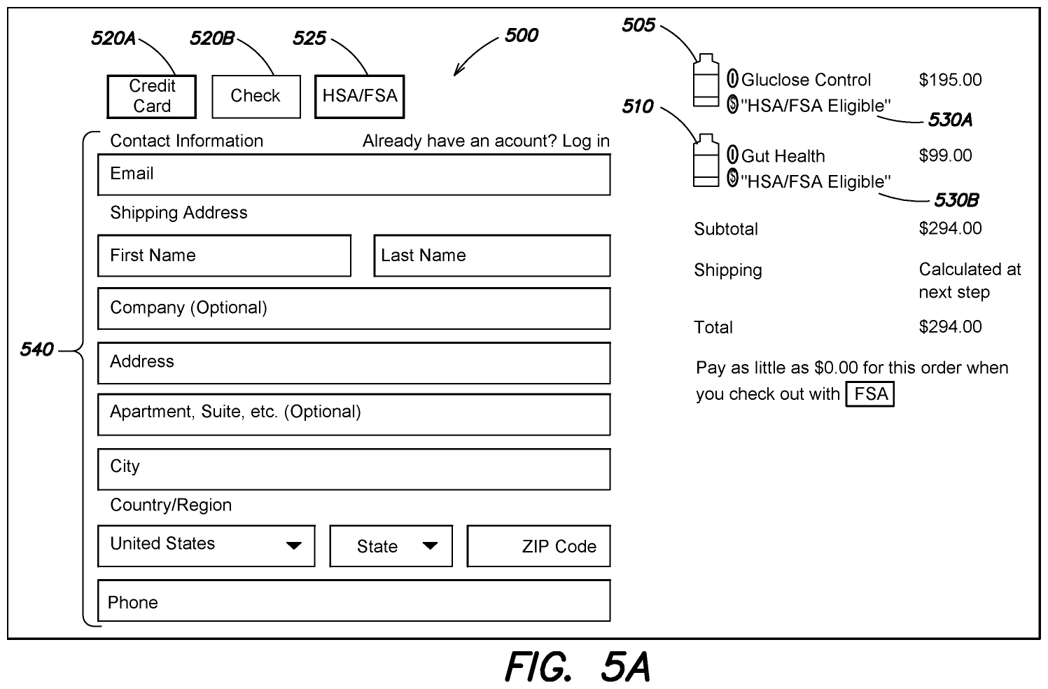

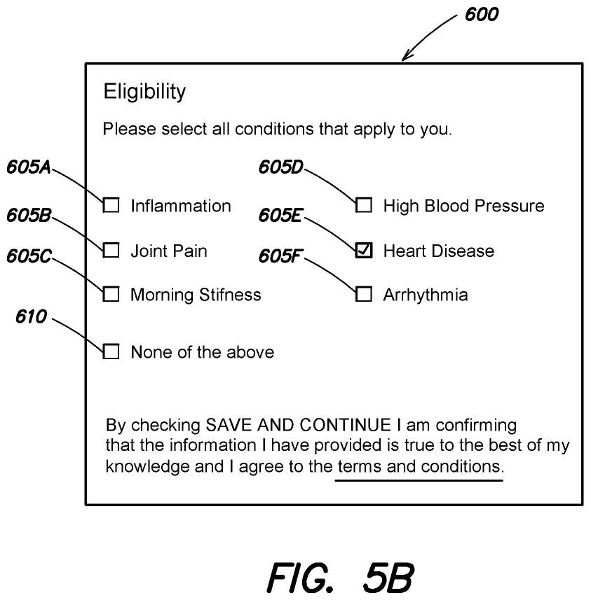

After determining purchase eligibility for one or more merchant product/services according to the one or more embodiments as described herein, the ETM 126 may generate one or more user interfaces that provide an indication regarding the determine purchase eligibility. FIG. 5A is an example user interface 500 that may be generated based on the determined purchase eligibility in accordance with illustrative embodiments of the present invention.

For the example of FIG. 5A, the user (e.g., consumer) is interested in purchasing product 505 that is a bottle of Glucose control pills and product 510 that is a bottle of gut health pills. Specifically, and in this example, the user has selected products 505 and 510 from an online merchant, and the products 505 and 510 are in the user's online cart. As depicted in FIG. 5A, each of products 505 and 510 are displayed with their respective prices. Further, user interface 500 includes the total price for both products. Let it be assumed that both products 505 and 510 are determined to be eligible for purchase with an HSA/FSA account as described above and according to the one or more embodiments as described herein.

User interface 500 may include buttons 520A and 520B that are selectable such that the user can pay for the products 505 and 510 utilizing conventional payment options, e.g., a credit card, a checking account, etc. Based on the determinations that products 505 and 510 are eligible for purchase using an HSA/FSA account as described herein, the ETM 126 may also generate and display button 525 in user interface 500. Based on the selection of button 525, the user can purchase products 505 and 510 using an HSA/FSA account. In an implementation, the ETM 126 may generate user interface 500 without button 525 if both products 505 and 510 are determined to be non-eligible. As such, and in this implementation, user interface 500 would only include buttons 520A and 520B such that the user could only purchase products 505 and 510 utilizing conventional payment options.

Additionally, each product in the user's cart may have a tag 530 that indicates the eligibility of the product. In this example, both products 505 and 510 are determined to be eligible for purchase using an HSA/FSA account. As such, tags 530A and 530B both respectively indicate that the products 505 and 510 are “HSA/FSA Eligible”. If, for example, one of the products was conditionally eligible, tag 530 may indicate that the product is “HSA/FSA Conditionally Eligible”. Further, if a product is determined to be non-eligible, the tag may indicate that the product is “HSA/FSA Non-Eligible”.

The user interface 500 may also include other fields 540 where the customer can provide personal information (e.g., shipping information, email address, phone number, etc.) to complete the order of the products. Further, in an embodiment, the products may be organized based on the determined purchase eligibility according to the one or more embodiments as described herein. For example, let it be assumed that there are 10 products to be purchased by a consumer. Of those 10 products, 5 are eligible to be purchased with an HSA/FSA account, 3 are determined to be non-eligible to be purchased with an HSA/FSA account, and 2 are determined to be conditionally eligible to be purchased with an HSA/FSA account. As such, the ETM 126 may organize the products in the user interface 500 such that the 5 eligible products are visually grouped together, the 3 non-eligible products are grouped together, and the 2 conditionally eligible products are grouped together. Based on the groupings, the different eligible payment options for each group may be displayed with the group. Therefore, the non-eligible products would only be displayed with the conventional payment techniques, e.g., credit card and checking account.

FIG. 5B is an illustrative user interface 600 that may be generated for a product determined to be conditionally eligible in accordance with illustrative embodiments of the present invention. In this example, let it be assumed that a product (not shown) is for a stationary bike that is determined to be conditionally eligible for purchase using an HSA/FSA account according to the one or more embodiments described herein. In response to determining that the stationary bike is conditionally eligible, the ETM 126 may generate user interface 600 that can be utilized to determine if one or more conditions are satisfied. In the example of FIG. 6, there are plurality of selectable condition buttons 605A-605F that are user selectable. The user may select one or more of condition buttons 605A-605F to indicate one or more applicable conditions. The ETM 126 may then compare the selected conditions with those conditions that are required to be satisfied to determine whether the conditionally eligible stationary bike can be purchased using the HAS/FSA account.

In this example, the user has selected condition button 605E indicating that the user has heart disease. The ETM 126 may determine that heart disease is an acceptable condition such that the stationary bike can be purchased using the HAS/FSA account. Therefore, the ETM may generate a user interface similar to that of FIG. 5A that would include button 525 and tag 530 that would state that the stationary bike is “HSA/FSA eligible”. However, if the user has selected none of the above button 610, the ETM 126 may determine that a requisite condition has not been satisfied. Therefore, the ETM 126 would generate a user interface similar to that of FIG. 5A without button 525 and tag 530 that would state “HSA/FSA non-eligible” for the stationary bike.

Although the example of FIG. 6 requires user input to select condition buttons 605A-605F or none of the above button 610, it is expressly contemplated that the user interface 600 may operate in any of a variety of different ways to determine whether one or more conditions are satisfied for a conditionally eligible product. For example, the user interface 600 may include a user selectable button (not shown) that provides consent/permission for the electronic transaction platform 120 to access one or more records, e.g., medical records, of the user. Based on the provided consent/permission, the ETM 126 may determine if one or more requisite conditions are indicated in the records. If so, the ETM 126 may generate a user interface similar to that of FIG. 5A that would include button 525 and tag 530 that would state that the stationary bike is “HSA/FSA eligible”. If not, the ETM 126 may generate a user interface similar to that of FIG. 5A without button 525 and tag 530 that would state “HSA/FSA non-eligible” for the stationary bike.

With conventional techniques, and if a user tries to purchase a product/service utilizing an ineligible payment option, the electronic transaction might be declined and/or halted because the attempted payment option is invalid, and the user may be required to provide a different and valid, i.e., eligible, payment option. In this scenario, the electronic transaction data may need to be maintained (e.g., stored in memory or external d storage 129) until a valid payment option is provided by the consumer such that the electronic transaction can in fact be properly completed. Declining and/or halting an electronic transaction, which may be required by conventional techniques based on an invalid purchase attempt, hinders underlying computer functionality since processing resources are required to stop the payment option from proceeding, e.g., putting a hold or block on the payment option. Further, maintaining the electronic transaction information, which may be required by conventional techniques until a valid payment option is provided, consumes storage resources.

According to the one or more embodiments described herein, an end user can immediately purchase the product/service when at the merchant utilizing a particular payment option based on utilization of the merchant data structures 300A and 300B as described herein. Accordingly, the one or more embodiments described herein facilities electronic transactions based on purchase eligibility determinations for merchant products/services through use of the generated merchant data structures 300A and 300B. Because the merchant data structure 300A and 300B are utilized to initiate and complete online electronic purchases for product/services, the one or more embodiments described are not required to (1) decline or halt an electronic transaction that has been initiated with an invalid payment option, and (2) maintain the electronic transaction information until a valid payment option is provided. Accordingly, the one or more embodiments described herein conserve processing and storage resources when compared to conventional techniques and thus provide an improvement to the underlying computer, e.g., platform, functionality through improvements to the existing technology of electronic transaction processing.

What is claimed is:

1. An electronic transaction platform, comprising:
a processor coupled to a memory for storing an application, the processor configured to execute the application to:
generate an eligibility data structure configured to determine purchase eligibility; and
process the eligibility data structure using rule-based analysis and conditional logic of one or more natural language processing (NLP) techniques configured to:
identify an eligibility category from payment restriction information of one or more products or services based on (1) identifying a seed in the payment restriction information, and (2) determining that a selected word or phrase in the payment restriction information is at a particular location relative to the seed, wherein the selected word or phrase is the eligibility category; and
determine an eligibility classification for the eligibility category based on an identification of one or more predetermined words within an eligibility rule for the eligibility category, wherein the eligibility classification indicates that the eligibility category is either (1) eligible to be purchased with a selected payment option, (2) not eligible to be purchased with the selected payment option, or (3) conditionally eligible to be purchased with the selected payment option.

2. The electronic transaction platform of claim 1, wherein the processor is further configured to execute the application to:
receive payment restriction information from one or more different sources, wherein the payment restriction information describes the one or more products or services that can or cannot be purchased utilizing the selected payment option; and
determine an eligibility rule for the eligibility category, wherein the eligibility rule includes the seed and one or more other words that precede or follow the seed.

3. The electronic transaction platform of claim 1, wherein the one or more different sources include Internal Revenue Service (IRS) systems, health systems, employer document systems, benefit plan systems.

4. The electronic transaction platform of claim 1, wherein the processor is further configured to execute the application to:
receive merchant data from a selected merchant, wherein the merchant data describes a merchant product or service offered for sale by the selected merchant;
wherein the one or more NLP techniques are further configured to:
determine that one or more merchant keywords from the merchant data match or substantially match the eligibly category stored in the eligibility data structure;
in response to determining the match or substantial match, identify the eligibility classification in the eligibility data structure that corresponds to the eligibility category; and
assign the eligibility category to the merchant product or service.

5. The electronic transaction platform of claim 4, wherein the processor is further configured to execute the application to:
receive, from a client device operated by an end user to execute another application, a request to purchase the merchant product or service.

6. The electronic transaction platform of claim 5, wherein the processor is further configured to execute the application to:
transmit, over a computer network, an electronic message indicating that the selected payment option can be utilized by the client device to purchase the merchant product or service in response to determining that the eligibility classification assigned to the merchant product or service is eligible.

7. The electronic transaction platform of claim 5, wherein the processor is further configured to execute the application to:
transmit, over a computer network, an electronic message indicating that the selected payment option cannot be utilized by the client device to purchase the merchant product or service in response to determining that the eligibility classification assigned to the merchant product or service is not eligible.

8. The electronic transaction platform of claim 5, wherein the processor is further configured to execute the application to:
provide, over a computer network, one or more user interfaces requesting additional information from the end user of the client device in response to determining that the eligibility classification assigned to the merchant product or service is conditionally eligible.

9. The electronic transaction platform of claim 8, wherein the additional information that is requested is related to one or more medical conditions of the end user.

10. The electronic transaction platform of claim 5, wherein the processor is further configured to execute the application to:
determine that a first selected payment option can be utilized to purchase one or more first merchant products or services from the selected merchant utilizing the eligibility data structure in conjunction with the merchant data;
determine that the first selected payment option cannot be utilized to purchase one or more second merchant products or services from the selected merchant utilizing the eligibility data structure in conjunction with the merchant data; and
segregate, on a user interface of the client device, the one or more first merchant products or services from the one or more second merchant products or services, wherein the segregating visually delineates the one or more first merchant products or services from the one or more second merchant products or services on the user interface.

11. A computer implemented method, the method comprising:
generating, by the processor, an eligibility data structure configured to determine purchase eligibility; and
processing the eligibility data structure using rule-based analysis and conditional logic of one or more natural language processing (NLP) techniques comprising:
identifying an eligibility category from payment restriction information of one or more products or services based on (1) identifying a seed in the payment restriction information, and (2) determining that a selected word or phrase in the payment restriction information is at a particular location relative to the seed, wherein the selected word or phrase is the eligibility category; and
determining an eligibility classification for the eligibility category based on an identification of one or more predetermined words within an eligibility rule for the eligibility category, wherein the eligibility classification indicates that the eligibility category is either (1) eligible to be purchased with a selected payment option, (2) not eligible to be purchased with the selected payment option, or (3) conditionally eligible to be purchased with the selected payment option.

12. The method of claim 11, further comprising:
receiving payment restriction information from one or more different sources, wherein the payment restriction information describes the one or more products or services that can or cannot be purchased utilizing the selected payment option; and
determining an eligibility rule for the eligibility category, wherein the eligibility rule includes the seed and one or more other words that precede or follow the seed.

13. The method of claim 11, wherein the one or more different sources include Internal Revenue Service (IRS) systems, health systems, employer document systems, benefit plan systems.

14. The method of claim 11, the method further comprising:
receiving merchant data from a selected merchant, wherein the merchant data describes a merchant product or service offered for sale by the selected merchant;
wherein the processing using the one or more NLP techniques further comprises:
determining that one or more merchant keywords from the merchant data match or substantially match the eligibly category stored in the eligibility data structure;
in response to determining the match or substantial match, identifying the eligibility classification in the eligibility data structure that corresponds to the eligibility category; and
assigning the eligibility category to the merchant product or service.

15. The method of claim 14, further comprising:
receiving, from a client device operated by an end user, a request to purchase the merchant product or service.

16. The method of claim of claim 15, further comprising:
transmitting, over a computer network, an electronic message indicating that the selected payment option can be utilized by the client device to purchase the merchant product or service in response to determining that the eligibility classification assigned to the merchant product or service is eligible.

17. The method of claim of claim 15, further comprising:
transmitting, over a computer network, an electronic message indicating that the selected payment option cannot be utilized by the client device to purchase the merchant product or service in response to determining that the eligibility classification assigned to the merchant product or service is not eligible.

18. The method of claim of claim 15, further comprising:
providing, over a computer network, one or more user interfaces requesting additional information from the end user of the client device in response to determining that the eligibility classification assigned to the merchant product or service is conditionally eligible.

19. The method of claim of claim 15, further comprising:
determining that a first selected payment option can be utilized to purchase one or more first merchant products or services from the selected merchant utilizing the eligibility data structure in conjunction with the merchant data;
determining that the first selected payment option cannot be utilized to purchase one or more second merchant products or services from the selected merchant utilizing the eligibility data structure in conjunction with the merchant data; and
segregating, on a user interface of the client device, the one or more first merchant products or services from the one or more second merchant products or services, wherein the segregating visually delineates the one or more first merchant products or services from the one or more second merchant products or services on the user interface.

20. One or more non-transitory computer-readable media, having stored thereon instructions that when executed by a computing device, cause the computing device to perform operations comprising:
receiving payment restriction information from one or more different sources, wherein the payment restriction information describes products or services that can or cannot be purchased utilizing a selected payment option;
generating an eligibility data structure configured to determine purchase eligibility; and
processing the eligibility data structure using parsing, rule-based analysis and conditional logic of one or more natural language processing (NLP) techniques, wherein the processing using the one or more NLP techniques comprises:
identifying an eligibility category from the payment restriction information based on (1) identifying a seed in the payment restriction information, and (2) determining that a selected word or phrase in the payment restriction information is at a particular location relative to the seed, wherein the selected word or phrase is the eligibility category;
determining an eligibility rule for the eligibility category, wherein the eligibility rule includes the seed and one or more other words that precede or follow the seed; and
determining an eligibility classification for the eligibility category based on an identification of one or more predetermined words within the eligibility rule, wherein the eligibility classification indicates that the eligibility category is either (1) eligible to be purchased with the selected payment option, (2) not eligible to be purchased with the selected payment option, or (3) conditionally eligible to be purchased with the selected payment option.
